(19) United States
(12) Patent Application Publication
(10) Pub. No.: US 2003/0156524 A1
(43) Pub. Date: Aug. 21, 2003

(54) Holographic data memory

(76) Inventors: Stefan Stadler, Hamburg (DE); Matthias Gerspach, Dossenheim (DE); Christoph Dietrich, Heidelberg (DE); Jorn Leiber, Hamburg (DE); Steffen Noehte, Weinheim (DE)

Correspondence Address: NIXON & VANDERHYE, PC, 1100 N GLEBE ROAD, 8TH FLOOR, ARLINGTON, VA, 22201-4714, US

(21) Appl. No.: 10/343,981

(22) PCT Filed: May 23, 2001
(86) PCT No.: PCT/EP01/05931

(30) Foreign Application Priority Data
Aug. 11, 2000 (DE) 100 39 374.8

(51) Int. Cl. G11B 7/00; G03H 1/04

(52) U.S. Cl. 369/103; 430/1; 430/2

(57) ABSTRACT

A holographic data storage medium (1) has a storage layer (2) which contains a dye that can be changed, preferably bleached out or destroyed, by exposure to light. The storage layer (2) is set up for the storage of holographic information via the local absorption capacity in the storage layer (2). Preferably, a reflective layer (6) is arranged behind the storage layer (2).

The invention relates to a holographic data storage medium which can be used, for example, for storing image data such as photos, logos, text, and so on but also for the storage of other data.

In a hologram, holographic information about an object is contained distributed over the surface of the hologram, from which an image of the object can be reconstructed when it is irradiated with light, in particular coherent light from a laser. Holograms are used in industry in many ways, for example in the form of largely counterfeit-proof identifications. Identifications of this type will be found, for example, on credit cards or cheque cards; as what are known as white light holograms, they show a three-dimensional image of the object represented even when lit with natural light. Photographically produced holograms and embossed holograms are widespread, in which a relief structure is embossed into the surface of a material, at which the light used to reproduce the object is scattered in accordance with the information stored in the hologram, so that the reconstructed image of the object is produced by interference effects.

WO 00/17864 describes a data storage medium having an optical information carrier which contains a polymer film set up as a storage layer. The polymer film consists, for example, of biaxially oriented polypropylene. In the previously disclosed data storage medium, the polymer film is wound spirally in a plurality of layers onto a core, there being an adhesive layer in each case between adjacent layers. Information can be written into the data storage medium by the polymer film being heated locally with the aid of a write beam focused on a preselected layer from a data drive, as a result of which the refractive index of the polymer film and the reflective capacity at the interface of the polymer film change locally. This can be registered with the aid of an accordingly focused read beam in the data drive, since the read beam is reflected locally more or less intently in the interface of the polymer film, depending on the information written in.

It is an object of the invention to provide a holographic data storage medium which is cost-effective and has wide possible applications.

This object is achieved by a holographic data storage medium having the features of claim 1 and the use of a data storage medium according to claim 11. A method of putting information into such a data storage medium is specified in claim 13, a method of reading information from such a data storage medium in claim 17. Advantageous refinements of the invention are listed in the dependent claims.

The holographic data storage medium according to the invention has a storage layer which has a dye that can be changed, preferably bleached out or destroyed, by exposure to light. The storage layer is set up for the storage of holographic information via the local absorption capacity (absorptivity) in the storage layer.

When information is read out of the holographic data storage medium, the storage layer is transluminated, the absorption capacity in the storage layer, varying locally because of the changes in the dye, affecting the radiation, which permits the reconstruction of a holographic image. The local region for storing a unit of information (referred to as a “pit” in the following text) typically has linear dimensions (that is to say, for example, a side length or a diameter) of the order of magnitude of 0.5 μm to 1 μm, but other sizes are also possible. The holographic data storage medium according to the invention is cheap and can be used in many different ways.

The molecules of the dye are preferably bleached out or destroyed under exposure to radiation, which is used to put information into the holographic data storage medium. “Bleaching out” is understood to mean damaging the chromophoric system of a dye molecule by means of excitation with intensive light of suitable wavelength, without destroying the basic framework of the dye molecule in the process. The dye molecule loses it colour characteristics in the process and, given sufficient exposure for the light used for the bleaching, becomes optically transparent. If, on the other hand, the basic framework of a dye molecule is also destroyed, then the change effected by the exposure is referred to as “destruction” of the dye. The light used for the exposure, that is to say to put the information in, does not have to lie in the visible wavelength range.

Since the varying local absorption capacity in the storage layer is used to store holographic information, the storage layer is illuminated in transmission when reading out information. This can be done by a direct route, if it is permitted by the construction of the data storage medium and the device used to read information out. In an alternative refinement, a reflective layer is arranged behind the storage layer, so that the storage layer is transilluminated twice during the reading-out of information. A refinement of this type makes it possible, for example, to apply the storage layer to a nontransparent substrate.

A carrier is preferably provided for the storage layer. The carrier can, for example, have a polymer film which can also be configured as a transparent polymer film. However, it is also conceivable to use a nontransparent or a flexurally rigid carrier. Metals or plastics, for example, are considered.

In a preferred refinement of the invention, the storage layer has a polymer matrix in which the dye molecules are imbedded. The dye molecules are preferably distributed homogeneously in the storage layer or part of the storage layer. Materials recommended for the polymer matrix are polymers or copolymers of high optical quality, such as polymethylmethacrylate (PMMA) or, even better, the more temperature-stable polyimides or polyetherimides or polymethylpentene. Other examples are polycarbonate or cycloolefinic copolymers. During the production of a holographic data storage medium according to the invention, a polymer matrix which contains dye can be applied to a carrier, for example by spin coating or by doctoring on, or to a carrier previously provided with a reflective layer. Alternatively, printing techniques are also recommended to apply the dye to a carrier, the dye preferably likewise being embedded in a polymer matrix which serves as a binder.

Suitable as the dye are dyes which can be bleached out easily, such as azo and diazo dyes (for example the Sudan red family). For example, in the case of dyes from the Sudan red family, information can be put in using a write beam with an optical wavelength of 532 mm. However, dyes of this type are preferably not so unstable with respect to exposure that a bleaching process is already started by ambient light (sun, artificial illumination). If the write beam is produced by a laser, considerably higher intensities can be achieved in the storage layer than in the case of exposure by ambient light, so that dyes are available which permit a storage layer which is at least largely insensitive to ambient light. The dye therefore does not have to be sensitive to light, quite in contrast to a photographic film. If the dye of the storage layer is not bleached out, on the other hand, but is destroyed with a higher laser power, it is possible to have recourse to a large number of dyes. In this case, the absorption maximum of the respective dye is preferably matched to the wavelength of the laser used as a write beam. Further suitable dyes are polymethine dyes, arylmethine dyes and aza[18]annulene dyes.

In a preferred refinement of the invention, the holographic data storage medium has an adhesive layer for sticking the data storage medium to an object. The adhesive layer makes it possible to stick the data storage medium quickly and without difficulty to a desired object, for example to use the data storage medium as a machine-readable label in which information about the object is stored. Particularly suitable as an adhesive layer is a self-adhesive layer or a layer with a pressure-sensitive adhesive, which, in the delivered state of the data storage medium, is preferably provided with a protective covering that can be pulled off (for example of a film or a silicone paper).

Apart from the previously mentioned layers, the data storage medium according to the invention can also have additional layers, for example a protective layer of a transparent varnish or polymer which is arranged in front of the storage layer. An optional adhesive layer is preferably located behind the reflective layer or behind the mechanical carrier.

Information to be stored can be input into the holographic data storage medium according to the invention by means of a method in which holographic information contained in a hologram of a storing object is calculated as a two-dimensional arrangement and a write beam from a writing device, preferably a laser lithograph, is aimed at a storage layer of the data storage medium and is driven in accordance with the two-dimensional arrangement in such a way that the local absorption capacity in the storage layer is set by a local change, preferably bleaching or destruction, in the dye in accordance with the holographic information. Since the physical processes in the scattering of light at a storing object are known, for example a conventional set-up for producing a hologram (in which coherent light from a laser, which is scattered by an object (storing object) is brought into interference with a coherent reference beam and the interference pattern produced in the process is recorded as a hologram) is simulated with the aid of a computer program, and the interference pattern is calculated as a two-dimensional arrangement (two-dimensional array). The resolution of a suitable laser lithograph is typically about 50 000 dpi (dots per inch). The absorption capacity in the storage layer can therefore be changed locally in regions or pits of a size of about 0.5 μm to 1 μm. The write speed and other details depend, inter alia, on the parameters of the write-laser (laser power, optical wavelength) and the exposure duration and also on the dye and the properties of the storage layer.

The holographic information is therefore preferably input into the storage layer in the form of pits of predefined size; the term “pit” is to be generally understood here as meaning a changed region rather than having its original meaning of (mechanical) hole. In this case, the holographic information can be stored in a pit in binary encoded form. This means that, in the region of a given pit, the storage layer assumes only one of two possible values for the absorption capacity. These values preferably differ considerably, in order that intermediate values occurring in practice for the absorption capacity which lie close to one or the other value can be assigned unambiguously to one or the other value, in order to store the information reliably and unambiguously.

Alternatively, the holographic information can be stored in continuously encoded form in a pit, the local absorption capacity in the pit being selected from a predefined value range. This means that, in a given pit, the absorption capacity in the storage layer can assume any desired value from a predefined value range. In this case, the information may therefore be stored “in grey stages”, so that each pit is given the information content from more than one bit.

In a method of reading information out of a holographic data storage medium according to the invention, light, preferably coherent light (for example from a laser) is aimed over a large area onto a storage layer of the data storage medium, and the storage layer of the data storage medium is illuminated in transmission, the light possibly being reflected at the reflective layer (if one such is present) behind the storage layer. As a reconstruction of the holographic information contained in the illuminated region, a holographic image is registered at a distance from the data storage medium, for example by using a CCD sensor which is connected to a data processing device.

The term “large area” is to be understood to mean an area which is considerably larger than the area of a pit. In this sense, for example, an area of 1 mm is a large area. For the scheme according to which information is stored in a holographic data storage medium according to the invention and read out, there are many different possibilities. It is conceivable to read out from the data storage medium in one operation, by the entire area of the storage layer being illuminated in one operation. In particular in the case of larger areas, however, it is advantageous to divide up the information to be stored into a number or large number of individual regions (for example with a respective area of 1 mm²) and to read out the information only from a predefined individual area in one operation.

When information is read out, the illuminated region of the storage layer acts as a diffraction grating, the incident light being deflected in a defined manner as a result of the locally varying absorption capacity. The deflected light forms a holographic image of the stored object. This image represents the reconstruction of the information encoded via the varying absorption capacity (amplitude modulation).

The holographic data storage medium according to the invention can be used for different types of stored objects. For example, both the information contained in images, such as photographs, logos, texts, and so on, and machine-readable data can be stored and read out. The latter is carried out, for example, in the form of data pages, as they are known, the holographic information contained in a hologram of a graphic bit pattern (which represents the data information) being input into the storage layer as explained. When the said data is read out, a holographic image of this graphic bit pattern is produced. The information contained therein can be registered, for example with the aid of an accurately adjusted CCD sensor, and processed by associated evaluation software. For the reproduction of images, in which high accuracy is not an issue, in principle even a simple matt disc, or, for example, a camera with an LCD screen is sufficient.

In the case of the holographic storage of machine-readable data, it is advantageous that the information does not have to be read out sequentially but that an entire data set can be registered in one operation, as explained. Should the surface of the storage layer be damaged, then, as opposed to a conventional data storage medium, this does not lead to a loss of data but only to a worsening of the resolution of the holographic image reconstructed when the information is read out, which is generally not a problem.

The holographic data storage medium according to the invention may also be used for the storage of direct information. This means that the local absorption capacity in the storage layer is set in such a way that the desired information is deposited in the storage layer as directly detectable information, for example as an image or line of text. In order to read this direct information, no holographic construction nor any coherent light is required. Depending on the area of the storage layer used, it may be appropriate to use a magnifying glass or a microscope as an aid to viewing.

In the following text, the invention will be explained further using exemplary embodiments. In the drawings

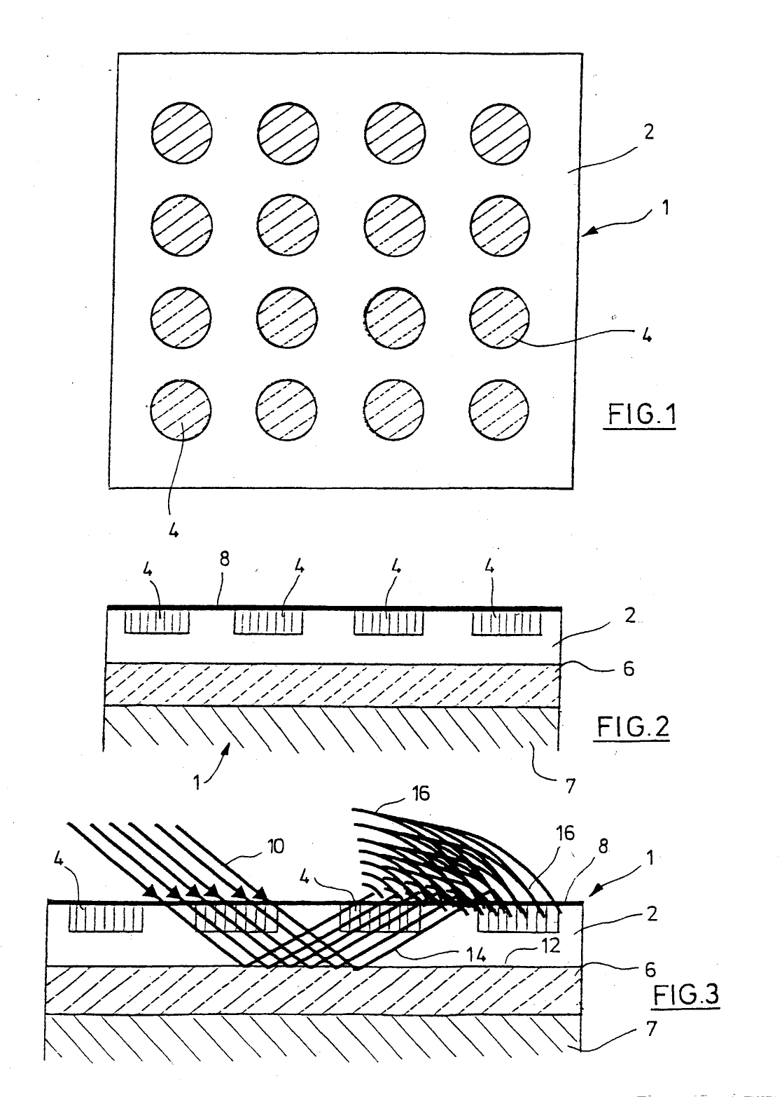

FIG. 1 shows a schematic plan view of a detail from a holographic data storage medium according to the invention,

FIG. 2 shows a longitudinal section through the holographic data storage medium from FIG. 1 and

FIG. 3 shows a longitudinal section through the holographic data storage medium from FIG. 1, the processes during the reading of information being illustrated in a schematic way.

FIG. 1 is a schematic plan view of one embodiment of a holographic data storage medium 1 into which information is put. The data storage medium 1 has a polymer matrix which is set up as a storage layer 2 and in which dye molecules are embedded. In the exemplary embodiment, the polymer matrix consists of polymethylmethacrylate (PMMA) and has a thickness of 1 μm. Other thicknesses are likewise possible. In the exemplary embodiment, the dye used is Sudan red in a concentration such that the result over the thickness of the storage layer 2 is an optical density of 0.8, if the dye in the storage layer 2 is not changed by exposure.

The optical density is a measure of the absorption, here based on the optical wavelength of a write beam. The optical density is defined as the negative decimal logarithm of the transmission through the storage layer 2, which agrees with the product of the extinction coefficient at the wavelengths of the write beam used, the concentration of the dye in the storage layer 2 and the thickness of the storage layer 2. Preferred values for the optical density lie in the range from 0.2 to 1.0; however other values are likewise conceivable.

In the data storage medium 1, information is stored in the form of pits 4. In the region of a pit 4, the absorption capacity in the storage layer 2 is different from that in the zones between the pits 4. In this case, the information can be stored in a pit in binary encoded form, by the absorption capacity assuming only two different values (it being possible for one of the two values also to coincide with the absorption capacity in the storage layer 2 in the zones between the pits 4). It is also possible to store the information in a pit 4 in continuously encoded form, it being possible for the absorption capacity within the pit 4 to assume any desired selected value from a predefined value range. Expressed in an illustrative way, in the case of storage in binary encoded form, a pit is “black” or “white”, while in the case of storage in continuously encoded form, it can also assume all the grey values lying between.

In the exemplary embodiment, a pit 4 has a diameter of about 0.8 μm. Forms other than circular pits 4 are likewise possible, for example square or rectangular pits, but also other sizes. The typical dimension of a pit is preferably about 0.5 μm to 1.0 μm. FIG. 1 is therefore a highly enlarged illustration and merely shows a detail from the data storage medium 1.

FIG. 2 illustrates a detail from the data storage medium 1 in a schematic longitudinal section, specifically not to scale. It can be seen that in the exemplary embodiment a pit 4 does not extend over the complete thickness of the storage layer 2. In practice, owing to the writing method for inputting information, in which the dye in the storage layer 2 is changed in the region of a pit 4 using a focused write beam, the transition zone in the lower region of a pit 4 to the lower region of the storage layer 2 is continuous, that is to say the absorption capacity changes gradually in this zone and is not delimited as sharply as shown in FIG. 2. The same applies to the lateral edges of a pit 4.

Under (that is to say behind) the storage layer 2 there is a reflective layer 6 which, in the exemplary embodiment, consists of aluminium. The reflective layer 6 can fulfil its function even if it is substantially thinner than the storage layer 2. The spacing of the lower regions of the pit 4 from the reflective layer 6 and the thickness of the storage layer 2 are preferably set up such that disruptive interference and superimposition effects are avoided.

The storage layer 2 and the reflective layer 6 are applied to a mechanical carrier 7 which, in the exemplary embodiment, consists of a polymer film of biaxially oriented polypropylene of 50 μm thickness. Other dimensions and materials for a polymer film, but also flexurally rigid carriers, are likewise possible. However, it is also conceivable to design the storage layer 2 to be self-supporting. A protective layer 8 is applied to the upper side of the storage layer 2.

In the exemplary embodiment, in order to produce the data storage medium 1, first of all the reflective layer 6 of aluminium is vapour-deposited on the carrier 7, then the polymer matrix with the dye of the storage layer 2 is doctored on and the protective layer 8 is finally applied. As an option, a self-adhesive layer, not illustrated in the figures, can also be arranged under the carrier 7.

In order to put information into the data storage medium 1, first of all holographic information contained in a hologram of a stored object is calculated as a two-dimensional arrangement (amplitude modulation). This can be carried out, for example, as a simulation of a classical structure for producing a photographically recorded hologram, in which coherent light from a laser, after being scattered at the stored object, is brought into interference with a coherent reference beam, and the interference pattern produced in the process is recorded as a hologram. The two-dimensional arrangement (two-dimensional array) then contains the information which is required to drive the write beam of a laser lithograph. In the exemplary embodiment, the laser lithograph has a resolution of about 50 000 dpi (that is to say about 0.5 μm) The write beam of the laser lithograph is guided in pulsed operation (typical pulse duration of about 1 μs to 10 μs with irradiated power of about 1 mW to 10 mW in order to input a pit 4) over the storage layer 2 of the data storage medium 1, in order to put the desired information sequentially into the data storage medium 1 (or into a preselected region of the data storage medium 1). In the process, the write beam changes the dye in the storage layer 2 in accordance with the two-dimensional array and in this way produces the pits 4 as explained above.

FIG. 3 illustrates in a schematic way how the information stored in the data storage medium 1 can be read out. For this purpose, coherent light from a laser (preferably of a wavelength which is absorbed by the dye of the storage layer 2 to a significant extent) is aimed at the upper side of the data storage medium 1. For reasons of clarity, only a small detail of this preferably parallel incident coherent light is illustrated in FIG. 3 and is designated by 10 (incident read beam). In practice, the coherent light is aimed at the storage layer 2 over a large area and covers a region of, for example, 1 mm². This is because the light originating from many pits 4 must be registered in order to reconstruct the stored information. The intensity of the incident read beam 10 is too weak to change the dye in the storage layer 2 and therefore the stored information.

The incident read beam 10 which, for practical reasons, strikes the surface of the data storage medium 1 at an angle, illuminates the storage layer 2 and is reflected at the interface 12 between the storage layer 2 and the reflective layer 6, so that a reflected read beam 14 emerges from the interface 12. In the process, the pits 4 with their different local absorption capacity are penetrated, which has the effect of amplitude modulation with periodically different absorption of light. The incident read beam 10 is deflected in a defined manner such that the result is that spherical waves 16 emerge from the data storage medium 1 in the manner of a diffraction grating, and reproduce the stored holographic information. At some distance from the data storage medium 2, a detector can be used to register a holographic image, which is brought about by interference between the spherical waves 16. The read beam is also reflected and possibly modulated (not shown in FIG. 3 for clarity) at the interface between the data storage medium 1 and air, but considerably more weakly. Nevertheless, by means of a suitable choice of the materials and layer thicknesses, it must be ensured that disruptive interference between the various reflected beams does not occur.

The expenditure required for the detector and the further processing of the registered holographic image depend on the type of stored object, as already explained further above. For the reproduction of machine-readable data (data pages), a CCD sensor connected to a data processing device is particularly suitable, while for pure image reproduction, a simpler detector is practical, in particular if the image data are not to be processed further.

Apart from the layers which can be seen in FIG. 2, the data storage medium 1 can have additional layers, for example an adhesive layer underneath the carrier. With the aid of such an adhesive layer, the data storage medium 1 can be stuck directly to an object. In this way, the data storage medium 1 can be used as a type of label which contains virtually invisible information which may be decoded only with the aid of a holographic construction for reading information.

If a dye that is invisible in visible light (for example which absorbs in the infrared) is used, the data storage medium may be configured to be largely transparent and very inconspicuous. A data storage medium of this type does not lead to any optical detriment of an object on which it is used as a label.

1. Holographic data storage medium, having a storage layer (2) which has a dye which can be changed, preferably bleached out or destroyed, by exposure to light and which storage layer is set up for the storage of holographic information via the local absorption capacity in the storage layer (2).

2. Holographic data storage medium according to claim 1, characterized in that a reflective layer (6) is arranged behind the storage layer (2).

3. Holographic data storage medium according to claim 1 or 2, characterized by a carrier (7) for the storage layer (2).

4. Holographic data storage medium according to claim 3, characterized in that the carrier (7) has a polymer film.

5. Holographic data storage medium according to one of claims 1 to 4, characterized in that the storage layer (2) has a polymer matrix in which dye molecules are embedded.

6. Holographic data storage medium according to claim 5, characterized in that the polymer matrix has at least one polymer or copolymer selected from the following group: polymethylmethacrylate, polyimide, polyetherimide, polymethylpentene, polycarbonate, cycloolefinic copolymer.

7. Holographic data storage medium according to one of claims 1 to 6, characterized in that the dye has at least one dye selected from the following group: azo dyes, diazo dyes, polymethine dyes, arylmethine dyes, aza[18]annulene dyes.

8. Holographic data storage medium according to one of claims 1 to 7, characterized by stored holographic information.

9. Holographic data storage medium according to one of claims 1 to 8, characterized by stored direct information.

10. Holographic data storage medium according to one of claims 1 to 9, characterized by an adhesive layer for sticking the data storage medium (1) to an object.

11. Use of a data storage medium which has a storage layer (2) with a dye that can be changed, preferably bleached out or destroyed, by exposure to light, as a holographic data storage medium, it being possible for holographic information to be stored via the local absorption capacity in the storage layer (2).

12. Use according to claim 11, characterized in that the data storage medium (1) has the features of the holographic data storage medium according to one of claims 2 to 10.

13. Method of putting information into a holographic data storage medium according to one of claims 1 to 10, wherein holographic information contained in a hologram of a storing object is calculated as a two-dimensional array and a write beam of a writing device, preferably a laser lithograph, is aimed at a storage layer (2) of the data storage medium (1) and is driven in accordance with the two-dimensional array in such a way that the local absorption capacity in the storage layer (2) is set by a local change, preferably bleaching or destruction, in the dye in accordance with the holographic information.

14. Method according to claim 13, characterized in that the holographic information is input into the storage layer (2) in the form of pits (4) of predefined size.

15. Method according to claim 14, characterized in that the holographic information is stored in a pit (4) in binary encoded form.

16. Method according to claim 14, characterized in that the holographic information is stored in a pit (4) in continuously encoded form, the local absorption capacity in the pit (4) being selected from a predefined value range.

17. Method of reading information out of a holographic data storage medium according to one of claims 1 to 10, wherein light, preferably coherent light (10), is aimed over a large area onto a storage layer (2) of the data storage medium (1), the storage layer (2) of the data storage medium (1) is illuminated in transmission, the light optionally being reflected at the reflective layer (6) behind the storage layer (2), and a holographic image (16) is detected at a distance from the data storage medium (1) as a reconstruction of the holographic information contained in the illuminated area.

18. Method according to claim 17, characterized in that the holographic image is detected by a CCD sensor connected to a data processing device.
